(19) United States
(12) Patent Application Publication
(10) Pub. No.: US 2012/0262380 A1
(43) Pub. Date: Oct. 18, 2012

(54) APPARATUS, METHOD, COMPUTER PROGRAM AND USER INTERFACE

(75) Inventor: Ari-Heikki Ilari Sarjanoja, Oulu (FI)

(73) Assignee: Nokia Corporation

(21) Appl. No.: 13/087,687

(22) Filed: Apr. 15, 2011

(51) Int. Cl. G06F 3/041

(52) U.S. Cl. 345/173

(57) ABSTRACT

A method, apparatus, computer program and graphical user interface wherein the method comprises: providing a first portion 43 and a second portion 45 of a touch sensitive display 15 wherein the first portion 43 is configured to display content 47, 87 relating to at least one of a plurality of available tasks and the second portion 45 is configured to enable a user to make a user input to control the first portion 43; detecting a user input in the second portion 45; displaying, in response to the detected user input, at least one item 55, 57 indicating a function which may be performed on the first portion 43.

### TECHNOLOGICAL FIELD

Embodiments of the present invention relate to an apparatus, method, computer program and user interface. In particular, they relate to an apparatus, method, computer program and user interface for enabling a user to access a plurality of tasks.

### BACKGROUND

Apparatus which enable a plurality of tasks to be performed are known. It may be possible for the tasks to be performed simultaneously. In such cases it is useful to enable the user of the apparatus to access each of the different tasks which are currently available.

### BRIEF SUMMARY

According to various, but not necessarily all, embodiments of the invention there is provided a method comprising: providing a first portion and a second portion of a touch sensitive display wherein the first portion is configured to display content relating to at least one of a plurality of available tasks and the second portion is configured to enable a user to make a user input to control the first portion; detecting a user input in the second portion; displaying, in response to the detected user input, at least one item indicating a function which may be performed on the first portion.

In some embodiments of the invention the user input may comprise a trace user input.

In some embodiments of the invention the at least one item indicating a function may be displayed in the second portion.

In some embodiments of the invention the completion of the trace user input may enable the function indicated by the at least one item to be performed.

In some embodiments of the invention a visual indication may be provided on the touch sensitive display to indicate that the function will be enabled on completion of the trace user input.

In some embodiments of the invention the function which is performed may comprise changing the content displayed in the first portion from content associated with a first task to content associated with a second task.

In some embodiments of the invention the function which is performed may comprise minimising the first portion.

In some embodiments of the invention the function which is performed may comprise closing the first portion.

In some embodiments of the invention the boundaries of the first portion and the second portion may be indicated on the touch sensitive display.

In some embodiments of the invention content displayed in one portion might not obscure content displayed in the other portion.

In some embodiments of the invention the second portion may be configured to display an item indicating the content currently displayed in the first portion.

In some embodiments of the invention the first portion may comprise a plurality of tabs such that a first tab may be associated with a first task and a second tab may be associated with a second, different task wherein the first and second tasks may run simultaneously.

In some embodiments of the invention the plurality of tasks may be associated with the same application.

According to various, but not necessarily all, embodiments of the invention there is provided an apparatus comprising: at least one processor; and at least one memory including computer program code; wherein the at least one memory and the computer program code are configured to, with the at least one processor, enable the apparatus to: provide a first portion and a second portion of a touch sensitive display wherein the first portion is configured to display content relating to at least one of a plurality of available tasks and the second portion is configured to enable a user to make a user input to control the first portion; detect a user input in the second portion; enable the touch sensitive display to display, in response to the detected user input, at least one item indicating a function which may be performed on the first portion.

In some embodiments of the invention the user input may comprise a trace user input.

In some embodiments of the invention the apparatus may be configured to display the at least one item indicating a function in the second portion of the touch sensitive display.

In some embodiments of the invention the completion of the trace user input may enable the function indicated by the at least one item to be performed.

In some embodiments of the invention the apparatus may be further configured to provide a visual indication on the touch sensitive display to indicate that the function will be enabled on completion of the trace user input.

In some embodiments of the invention the function which may be performed may comprise changing the content displayed in the first portion from content associated with a first task to content associated with a second task.

In some embodiments of the invention the function which is performed may comprise minimising the first portion.

In some embodiments of the invention the function which is performed may comprise closing the first portion.

In some embodiments of the invention the boundaries of the first portion and the second portion may be indicated on the touch sensitive display.

In some embodiments of the invention the content displayed in one portion might not obscure content displayed in the other portion.

In some embodiments of the invention the second portion may be configured to display an item indicating the content currently displayed in the first portion.

In some embodiments of the invention the first portion may comprise a plurality of tabs such that a first tab may be associated with a first task and a second tab may be associated with a second, different task wherein the first and second tasks may run simultaneously.

In some embodiments of the invention the plurality of tasks may be associated with the same application.

According to various, but not necessarily all, embodiments of the invention there is provided a computer program comprising computer program instructions that, when executed by at least one processor, enable an apparatus at least to perform: providing a first portion and a second portion of a touch sensitive display wherein the first portion is configured to display content relating to at least one of a plurality of available tasks and the second portion is configured to enable a user to make a user input to control the first portion; detecting a user input in the second portion; displaying, in response to the detected user input, at least one item indicating a function which may be performed on the first portion.

In some embodiments of the invention the computer program may comprise computer program instructions for causing a computer to perform the method of any of the above paragraphs.

In some embodiments of the invention there may be provided a physical entity embodying the computer program of any of the above paragraphs.

In some embodiments of the invention there may be provided an electromagnetic carrier signal carrying the computer program as claimed in any of the above paragraphs.

According to various, but not necessarily all, embodiments of the invention there is provided a user interface comprising: a touch sensitive display:wherein the touch sensitive display is configured to provide a first portion and a second portion of a touch sensitive display wherein the first portion is configured to display content relating to at least one of a plurality of available tasks and the second portion is configured to enable a user to make a user input to control the first portion; detect a user input in the second portion; and display, in response to the detected user input, at least one item indicating a function which may be performed on the first portion.

In some embodiments of the invention the user input may comprise a trace user input.

The apparatus may be for wireless communications.

### BRIEF DESCRIPTION

For a better understanding of various examples of embodiments of the present invention reference will now be made by way of example only to the accompanying drawings in which:

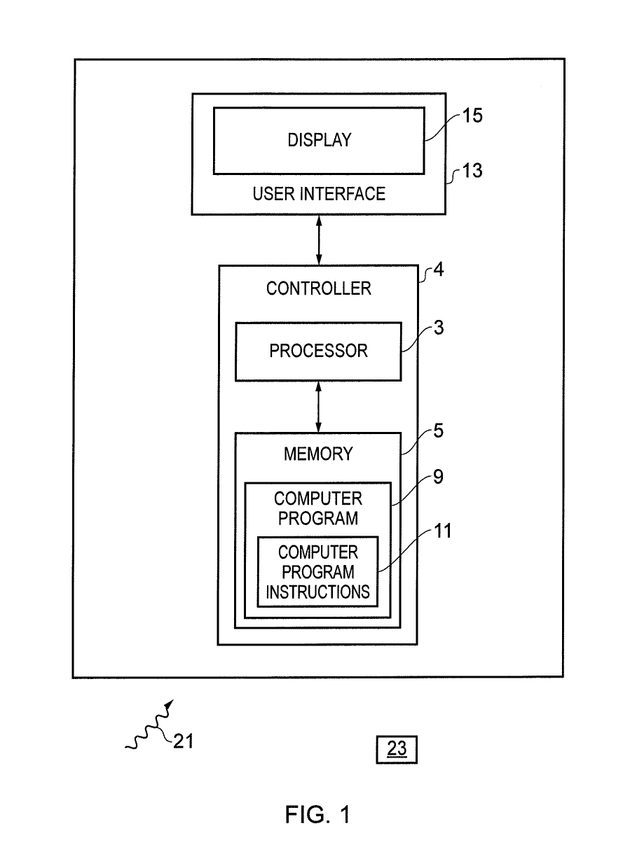

FIG. 1 schematically illustrates an apparatus according to an exemplary embodiment of the invention;

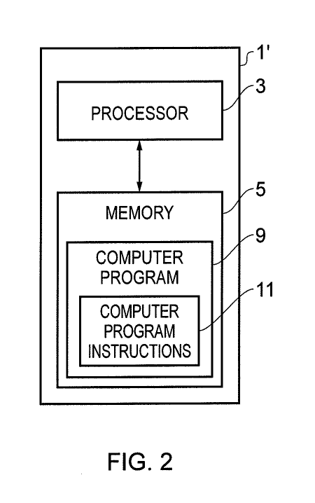

FIG. 2 schematically illustrates an apparatus according to another exemplary embodiment of the invention;

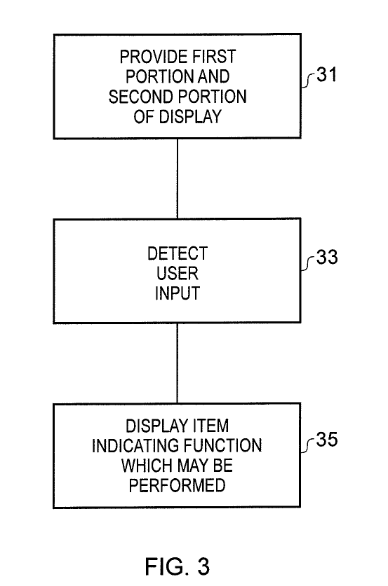

FIG. 3 is a block diagram which schematically illustrates a method according to an exemplary embodiment of the invention; and

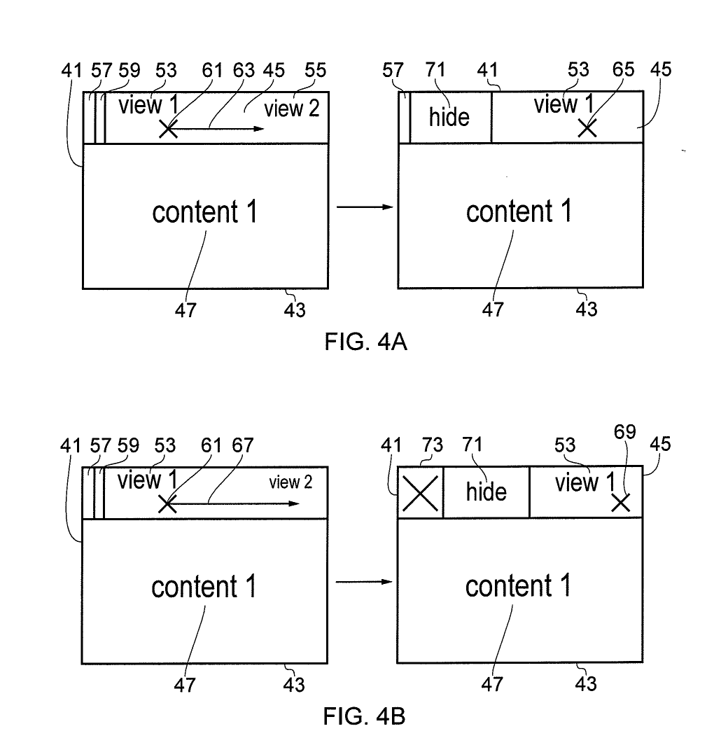

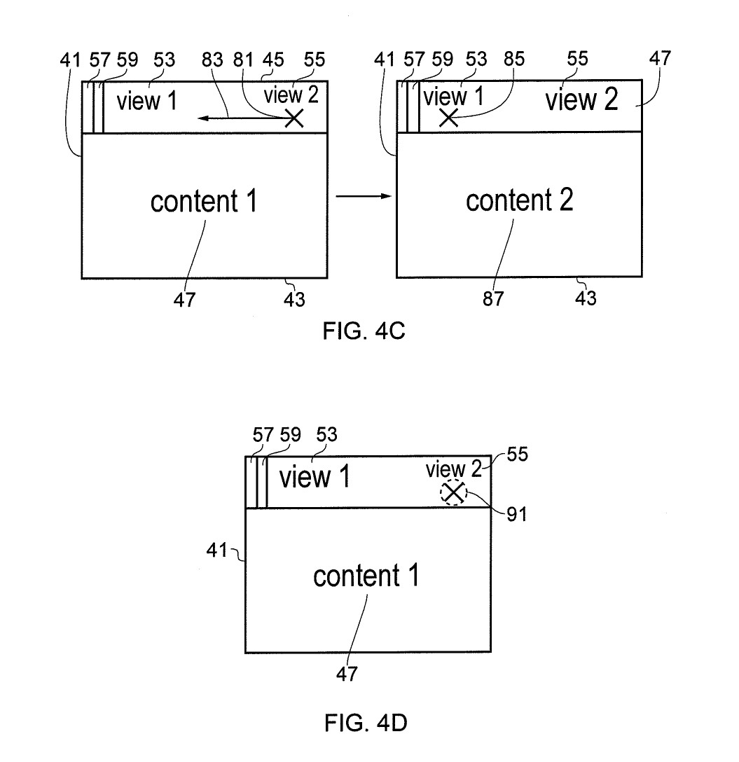

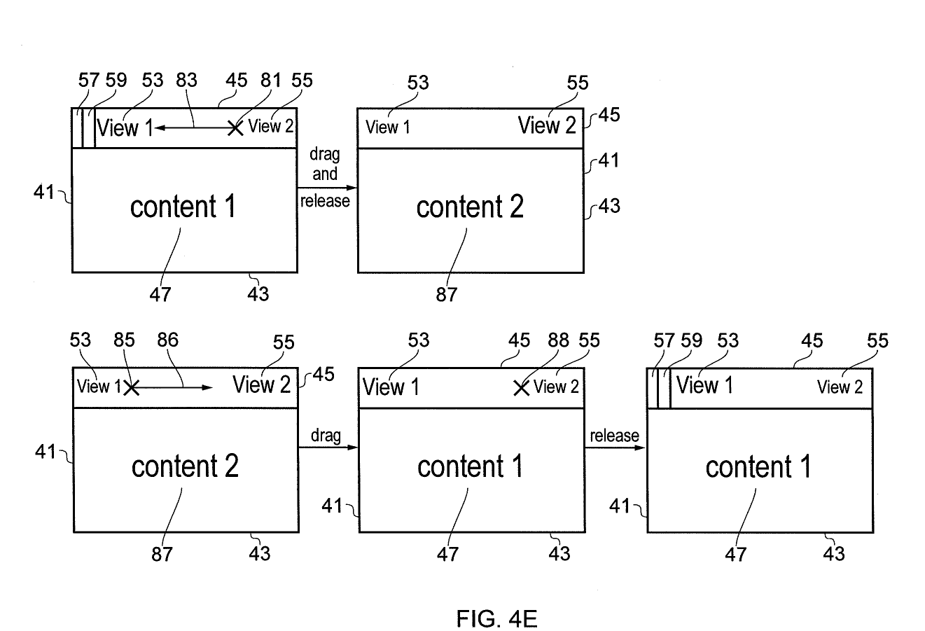

FIGS. 4A to 4E illustrate graphical user interfaces according to exemplary embodiments of the invention.

### DETAILED DESCRIPTION

The Figures illustrate a method comprising: providing a first portion 43 and a second portion 45 of a touch sensitive display 15 wherein the first portion 43 is configured to display content 47, 87 relating to at least one of a plurality of available tasks and the second portion 45 is configured to enable a user to make a user input to control the first portion 43; detecting a user input in the second portion 45; displaying, in response to the detected user input, at least one item 55, 57 indicating a function which may be performed on the first portion 43.

FIG. 1 schematically illustrates an apparatus 1 according to an embodiment of the invention. The apparatus 1 may be an electronic apparatus. The apparatus 1 may be, for example, a mobile cellular telephone, a tablet computer, a personal computer, a camera, a gaming device, a personal digital assistant, a personal music player or any other apparatus which may be configured to perform a plurality of tasks. The plurality of tasks may be performed simultaneously. The apparatus 1 may be a handheld apparatus 1 which can be carried in a user's hand, handbag or jacket pocket for example.

Only features of the apparatus 1 referred to in the following description are illustrated in FIGS. 1 and 2. However, it should be understood that the apparatus 1 may comprise additional features that are not illustrated. For example, in embodiments where the apparatus 1 is configured to enable communication the apparatus may also comprise one or more transmitters and receivers.

The exemplary apparatus 1 illustrated in FIG. 1 comprises: a user interface 13 and a controller 4. In the illustrated exemplary embodiment the controller 4 comprises at least one processor 3 and at least one memory 5 and the user interface 13 comprises at least a touch sensitive display 15.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of tasks. A task may be a specific function of an application. In some embodiments of the invention a task may comprise accessing a webpage and enabling the content of the webpage to be displayed on the display 15 of the apparatus 1. In some embodiments of the invention the tasks may comprise accessing different documents or files within an application such as a word processing or calendar application. In some other exemplary embodiments of the invention the tasks may relate to a communications or messaging application and the different tasks may comprise, for example, different message strings or other communication tasks.

The controller 4 may enable a plurality of different tasks to be performed simultaneously. For example a plurality of webpages may be accessed simultaneously. The different webpages may be displayed in different tabs on the display 15. The user interface 13 may be configured to enable the user of the apparatus 1 to switch between the different tabs and access the different available tasks.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The touch sensitive display 15 may comprise any means which enables information to be displayed to a user of the apparatus 1. The information may correspond to information which has been input by the user via the touch sensitive display 15 or any other user input device, information which is stored in the one or more memories 5 or information which has been received by apparatus 1. The information may also comprise content relating to one or more tasks which may be being performed by the apparatus 1.

The touch sensitive display 15 may be configured to display graphical user interfaces 41 as illustrated in FIGS. 4A to 4D.

The touch sensitive display 15 may comprise any means which is configured to detect touch inputs. A user of the apparatus 1 may make a touch input by actuating the surface of the touch sensitive display 15. The surface of the touch sensitive display 15 may be actuated by a user using their finger or thumb or any other suitable object such as a stylus to physically make contact with the surface. In some embodiments of the invention the user may also be able to actuate the touch sensitive display 15 by bringing their finger thumb or stylus close to the surface of the touch sensitive display 15. In exemplary embodiments of the invention the touch sensitive display 15 may be a capacitive touch sensitive display or a resistive touch sensitive display or any other suitable type of display.

The touch sensitive display 15 may be configured to detect different types of user input. For example, the touch sensitive display 15 may be configured to detect trace inputs or a long press input or any other type of actuation or combination or sequence of actuations. A user may make a trace input by actuating the surface of the touch sensitive display 15 and then dragging their finger, thumb or stylus across the surface. A user may make a long press input by actuating the same region of the surface of the touch sensitive display 15 for longer than a predetermined amount of time.

The output of the touch sensitive display 15 is provided as an input to the controller 4. The output of the touch sensitive display 15 may depend upon the type of actuation of the touch sensitive display 15 and also the location of the area actuated by the user input. The controller 4 may be configured to determine the type of input which has been made and also the location of the user input and enable the appropriate function to be performed in response to the detected input.

In some embodiments of the invention the user interface 13 may also comprise other user input devices in addition to a touch sensitive display 15 such as one or more keys, a joy stick, or any other user input device which enables a user of the apparatus 1 to control the apparatus 1.

The at least one memory 5 may be configured to store a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIG. 3. and described below. The at least one processor 3 by reading the at least one memory 5 is able to load and execute the computer program code 9.

The computer program instructions 11 may provide computer readable program means configured to control the apparatus 1. The program instructions 11 may provide, when loaded into the controller 4; means for providing a first portion 43 and a second portion 45 of a touch sensitive display 15 wherein the first portion 43 is configured to display content 47, 87 relating to at least one of a plurality of available tasks and the second portion 45 is configured to enable a user to make a user input to control the first portion 43; means for detecting a user input in the second portion 43; means for displaying, in response to the detected user input, at least one item 55, 57 indicating a function which may be performed on the first portion 43.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

FIG. 3 illustrates a method according to exemplary embodiments of the invention.

At block 31 the controller 4 controls the touch sensitive display 15 to provide a first portion 43 and a second portion 45 of the touch sensitive display 15. The first portion 43 may be configured to display content 47, 87 associated with tasks which are being performed by the apparatus 1 and are available to the user. The second portion 45 may be configured to enable the user of the apparatus 1 to control the first portion 43.

As described above the apparatus 1 may be configured to perform a plurality of tasks simultaneously. The apparatus 1 may be configured to enable the user of the apparatus 1 to access each of the available tasks, for example, the apparatus 1 may be configured to enable a user to view content associated with each of the available tasks. In some embodiments of the invention this may be achieved by using tabs. Different tasks may be associated with different tabs so that different tabs enable content associated with different tasks to be displayed on the touch sensitive display 15. The apparatus 1 may control the number of tabs which are displayed on the touch sensitive display 15 at any particular time. For example, in the embodiments of the invention illustrated in FIGS. 4A to 4D only one tab may be displayed on the display 15 at any given time. The first portion 43 may be configured to display the different tabs.

The second portion 45 of the touch sensitive display 15 may be configured to enable a user to control the first portion 43 of the touch sensitive display 15. For example the second portion may enable the user to make user inputs and control the first portion 43 to access the different available tasks. The second portion 45 may enable the user to directly control the first portion 43 just by actuating the second portion 45 without having to access a menu or navigate through a plurality of available functions.

The second portion 45 may be significantly smaller than the first portion 43. This may enable the maximum area of the touch sensitive display 15 to be used for displaying the content 47, 87 associated with the respective tasks. For example, in the exemplary embodiments illustrated in FIGS. 4A to 4D the second portion 45 comprises a relatively narrow strip at the top of the touch sensitive display 15 while the first portion 43 comprises most of the touch sensitive display 15.

The first portion 43 and the second portion 45 may be displayed so that they do not overlap each other. For example, in the embodiments illustrated in FIGS. 4A to 4D the first portion 43 and the second portion 45 are displayed adjacent to each other. This prevents any items in displayed in the second portion 45 obscuring content displayed in the first portion 43 and vice versa.

It is to be appreciated that in some embodiments of the invention the first portion 43 and the second portion 45 may be displayed in a different configuration to that illustrated in the figures. For example, in some embodiments of the invention the first portion 43 and the second portion 45 could overlap. In such cases the overlaying portions may be transparent to enable the underlaying portions to be viewed.

The boundaries of the first portion 43 and the second portion 45 may be indicated on the touch sensitive display 15. The boundaries could be indicated by a line or a change in shading for example. This may enable a user to distinguish between the first portion 43 and the second portion 45. This may make it easier for the user to make the user inputs in the correct portion of the touch sensitive display 15.

In some embodiments of the invention the second portion 45 may comprise an item 53 which indicates the content 47, 87 which is currently being displayed in the first portion 43. In the exemplary embodiments illustrated in FIGS. 4A to 4D the item 53 indicates which task the currently displayed content is associated with. By including this item 53 in the second portion 45 this enables a larger area of the touch sensitive display 15 to be available for the display of the content.

At block 33 the controller 4 detects a user input. The controller 4 may also determine the type of user input and the function associated with user input.

The detected user input may comprise a trace user input which starts in the second portion 45 of the touch sensitive display 15. In some embodiments of the invention the trace user input may also end in the second portion 43 of the touch sensitive display 15. In some embodiments of the invention the trace user input may be made entirely within the second portion 43. This may enable the trace user input to be made without obscuring the view of content being displayed in the first portion 45. The function which is associated with the detected user input may depend upon the direction in which the trace has been made, the length of the detected trace and whether or not the trace input remains in the second potion 43 of the touch sensitive display 15.

At block 35, in response to the detection of the trace user input the controller 4 controls the touch sensitive display 15 to display at least one item 55, 57 indicative of a function which may be performed on the first portion 43.

The display of the item 55, 57 indicative of a function which may be performed provides an indication to the user of the functions which are available. In exemplary embodiments of the invention the function may only be performed once the trace user input has been completed. For example once the user has lifted their finger or stylus from the touch sensitive display 15 the trace user input may be determined to be completed and the function associated with the displayed item may be performed on the first portion 43. In other embodiments of the invention a further user input may be needed once the trace has been completed, for example it may be necessary for a user to actuate the area of the touch sensitive display 15 in which the item 55, 57 is displayed.

A plurality of different functions may be available and different items 55, 57 may be displayed in response to different detected user inputs. For example a first item may be displayed in response to the detection of a short trace input while a second, different item maybe displayed in response to detection of a long trace input.

The functions which are available may enable a user to control the first portion 43. For example, a first function may enable a user to switch between different tabs to change which task currently has its' content displayed in the first portion 43. Another function may enable a tab associated with a first task to be minimized. When a tab is minimized it may be hidden on the touch sensitive display 15 to enable other tabs to be displayed on the touch sensitive display 15 without ending the task. Another function may enable a tab to be closed. Once a tab is closed the content previously displayed in the tab is no longer displayed and the task associated with the tab is terminated. It is to be appreciated by a person skilled in the art that other functions may also be available.

Exemplary graphical user interfaces 41 according to embodiments of the invention are shown in FIGS. 4A to 4E.

FIG. 4A illustrates a graphical user interface 41 in which the apparatus 1 is performing a plurality of tasks so a plurality of different tasks are available for the user to view the content. As described above the graphical user interface 41 may be displayed on a touch sensitive display 15 and comprises a first portion 43 and a second portion 45.

The first portion 43 is configured to display content 47 associated with respective tasks. The second portion 45 is configured to enable a user to control the first portion 43. The second portion comprises an item 53 which indicates which content is currently being displayed in the first portion 43. In the exemplary embodiment illustrated in FIG. 4A the item 53 comprises a label “view 1” and indicates that “content 1” is currently displayed in the first portion 43.

In the exemplary graphical user interface 41 illustrated in FIG. 4A the second portion also comprises a second item 55. The second item 55 indicates that other tasks and other views of content are available. The second item 55 may be displayed differently to the first item 53 to make it clear to the user which item is indicative of the currently displayed content. In the exemplary graphical user interface 41 the second item 55 is displayed smaller than the first item 53, in other embodiments of the invention the first item 53 may be highlighted or the second item 55 may be grayed out.

The exemplary graphical user interface 41 illustrated in FIG. 4A also comprises a first stub 57 and a second stub 59 at the left hand side of the second portion 45. The stubs 57, 59 indicate that there are further functions available to the user but, in the illustrated embodiment, the stubs 57, 59 do not provide an indication of the actual function associated with the stub 57, 59.

In the exemplary graphical user interface 41 the first portion 43 and the second portion 45 are displayed adjacent to each other. The second portion 45 comprises a relatively narrow strip at the top of the touch sensitive display 15 while the first portion 43 comprises most of the touch sensitive display 15. It would be appreciated by a person skilled in the art that other configurations of the first and second portions 43, 45 may be used in other embodiments of the invention.

In FIG. 4A the user makes a trace user input in the second portion 45 of the touch sensitive display 15. In this first example the trace starts at the point 61 towards the left hand side of the second portion 45 and extends in a direction towards the right hand side of the touch sensitive display 15 as indicated by the arrow 63. In the embodiment illustrated in FIG. 4A the trace input remains in the second portion 45 and does not extend into the first portion 43 or any other portion of the touch sensitive display 15. The trace input may end at the point 65 which is located towards the right hand side of the second portion 45.

In response to the detection 33 of the trace user input the controller 4 controls the touch sensitive display 15 to display an item 71 indicative of a function which may be performed on the first portion 43. In this exemplary embodiment the item 71 comprises the label “hide” and indicates that the function of minimizing or hiding the content 47 currently displayed in the first portion 43 is available. The “hide” label may be highlighted to confirm that the function of hiding would be enabled in response to the completion of the trace user input.

In the exemplary embodiment illustrated in FIG. 4A the item 71 has replaced the stub 59 on the touch sensitive display 15. The second item 55 is no longer displayed in the second portion 45. The respective items may move as the user makes the trace user input. This may give the user the feeling that they are scrolling through the available functions and may make the user input more intuitive for the use to make.

In some embodiments of the invention the item 71 may merely indicate that the function of hiding or minimizing content is available. It may be necessary for a further user input to be detected before the function is implemented. For example the further user input which must be detected may comprise the user completing the trace by removing their finger from the touch sensitive display 15. In other embodiments of the invention the further user input may comprise actuation of the area of the touch sensitive display 15 in which the item 71 is displayed.

FIG. 4B illustrates a graphical user interface 41 according to a second example. The graphical user interface 41 illustrated in FIG. 4B is the same as that illustrated in FIG. 4A and described above.

In FIG. 4B the user also makes a trace user input in the second portion 45 of the touch sensitive display 15. In this second example the trace starts at the point 61 towards the left hand side of the second portion 45 as with the example described above. This trace input also extends in a direction towards the right hand side of the touch sensitive display 15 as indicated by the arrow 67. However, the trace input in the second example is longer than the trace input in the first example and so extends to point 69 which is closer to the right hand side of the second portion than point 65.

In response to the detection 33 of the trace user input illustrated in FIG. 4B the controller 4 controls the touch sensitive display 15 to display both item 71, as described above, and also item 73. Item 73 comprises the label “X” and indicates that the function of closing the tab and terminating the task corresponding to the content 47 currently displayed in the first portion 43 is available.

In FIG. 4B the item 71 has replaced the stub 59 and the item 73 has replaced the stub 57 on the touch sensitive display 15. As in FIG. 4A once the user has made the trace user input, the second item 55 is no longer displayed in the second portion 55.

In FIG. 4B, two items 73, 71 indicative of functions are displayed in the second portion 45. In embodiments of the invention where the function is enabled in response to the completion of the trace user input, the function which is enabled may be a function associated with the item 73 which has most recently been added to the display. In the example illustrated in FIG. 4B this would be the function of closing the tab. In other embodiments of the invention the further user input may comprise actuation of the area of the touch sensitive display 15 in which the items 71, 73 are displayed and the user may be able to select between the available items. The respective items 71, 73 may be highlighted to indicate to a user which item will be performed on completion of a user input.

FIG. 4C illustrates a graphical user interface 41 according to a third example. The graphical user interface 41 illustrated in FIG. 4C is the same as that illustrated in FIGS. 4A and 4B and described above.

In FIG. 4C the user also makes a trace user input in the second portion 45 of the touch sensitive display 15. However in this third example the trace starts at the point 81 towards the right hand side of the second portion 45 which is different to the examples described above. This trace input also extends from point 81 in a direction towards the left hand side of the touch sensitive display 15 as indicated by the arrow 83 to the point 85 which is towards the left hand side of the touch sensitive display 15.

In response to the detection 33 of the trace user input illustrated in FIG. 4C the controller 4 controls the touch sensitive display 15 to change the tab currently displayed in the touch sensitive display 15. In the example illustrated in FIG. 4C the content 47 associated with a first task is replaced in the first portion with content 87 associated with a second task.

As the content displayed in the first portion 43 has changed, the items 53, 55 displayed in the second portion 45 have also changed to indicate to a user that the content 87 now displayed is associated with a second task. The second item 55 is now displayed more prominently than the first item 53 to make it clear to the user that the content 87 displayed is associated with the second task. In the exemplary graphical user interface 41 the second item 55 is now displayed larger than the first item 53. It would be appreciated by a person skilled in the art that other means could be used to make the second item 55 displayed more prominently than the first item 53.

A user may be able to return the content 47 associated with the first task by making a trace from the point 85 at the left hand side of the second potion 45 back towards the point 81 at the right hand side of the second portion 45. It is to be appreciated that in embodiments of the invention there may be more than two tasks running simultaneously and more than two views available to a user. In such circumstances a user may be able to switch between the different views using the user inputs as described above.

FIG. 4D illustrates a graphical user interface 41 according to a third example. The graphical user interface 41 illustrated in FIG. 4D is the same as that illustrated in FIGS. 4A, 4B and 4C and described above.

In the example illustrated in FIG. 4D the user can switch from the content 47 associated with the first task to the content 87 associated with the second task by actuating the area 91 in which the item 55 is displayed. The actuation may comprise a short touch or a long touch or a double touch of the area 91. this may provide a user with a quick route of switching between different tabs without having to make a trace user input.

FIG. 4E illustrates a graphical user interface 41 according to a third example. The graphical user interface 41 illustrated in FIG. 4E is the same as that illustrated in FIGS. 4A, 4B, 4C and 4D described above.

In FIG. 4E the user initially makes a trace user input in the second portion 45 of the touch sensitive display 15 similar to the trace user input illustrated in FIG. 4C. The trace starts at the point 81 towards the right hand side of the second portion 45 and extends from point 81 in a direction towards the left hand side of the touch sensitive display 15 as indicated by the arrow 83. The trace input ends at the point 85 which is towards the left hand side of the touch sensitive display 15.

In response to the detection 33 of the first trace user input illustrated in FIG. 4E the controller 4 controls the touch sensitive display 15 to change the tab currently displayed in the touch sensitive display 15 and replace the content 47 associated with the first task with content 87 associated with a second task. The items 53, 55 displayed in the second portion 45 are also changed to indicate to a user that the content 87 now displayed is associated with a second task. The second item 55 is now displayed more prominently than the first item 53 to make it clear to the user that the content 87 displayed is associated with the second task.

In the exemplary embodiment illustrated in FIG. 4E The stubs 57 and 59 are no longer displayed in the second portion 45 when content 87 associated with the second task is displayed in the first portion 43.

In FIG. 4E once the content 87 associated with the second task is displayed in the first portion 43 the user may make a further trace input to switch back to the first content 47. This trace user input may comprise a trace user input starting at point 85 and extending in the general direction of the arrow 86 towards the right hand side of the touch sensitive display 15. The trace may end at point 88. In response to the detection 33 of the first trace user input illustrated in FIG. 4E the controller 4 controls the touch sensitive display 15 to change the tab currently displayed in the touch sensitive display 15 and switch back to the content 47 associated with the first task.

When the user completes the trace user input by lifting their finger from the touch sensitive display 15 the stubs 57 and 59 may be displayed in the second portion 45 again.

In the embodiment illustrated in FIG. 4E the stubs 57, 59 and the associated functions are only available when the first content 47 is being displayed in the first portion 43. This may provide the advantage that it reduces the likelihood of the user inadvertently selecting one of the functions when switching between the available content. It can be seen from FIG. 4E that the trace user input which is made to switch from the second content 87 back to the first content 47 comprises a trace extending towards the right hand side of the touch sensitive display 15. This user input is similar to the user inputs illustrated in FIGS. 4A and 4B to enable the functions of hiding and closing content. By only displaying the stubs 57, 59 and enabling the access to the associated functions when the first content 47 is being displayed this makes the apparatus 1 easier for a user to control as they can easily switch between different content without accidentally enabling other functions.

As the stubs 57, 59 are only displayed when the first content 47 is displayed in the first portion 43 this may also provide an indication to the user that the content currently on the display is the first content 47. This may allow for a hierarchical structure of the different tabs and associated tasks.

Embodiments of the invention as described above provide the advantage that they enable a user to easily access functions which enable them to control the content displayed on a touch sensitive display 15 even though the functions are not displayed on the touch sensitive display 15. This leaves a larger area of the display available for displaying the content associated with the available tasks. This may be particularly beneficial in apparatus 1 where the size of the display is limited such as a handheld electronic apparatus.

Also the trace user input which is used in some embodiments of the invention may create a scrolling gesture which may make the input simple and intuitive for a user to use.

The blocks illustrated in the FIG. 3 may represent steps in a method and/or sections of code in the computer program code 9. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example in the above described embodiments the functions of closing, minimizing or switching tabs are available. It would be appreciated that other functions relating to controlling the first portion may be available in other embodiments of the invention.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method comprising:
providing a first portion and a second portion of a touch sensitive display wherein the first portion is configured to display content relating to at least one of a plurality of available tasks and the second portion is configured to enable a user to make a user input to control the first portion;
detecting a user input in the second portion;
displaying, in response to the detected user input, at least one item indicating a function which may be performed on the first portion.

2. A method as claimed in claim 1 wherein the user input comprises a trace user input.

3. A method as claimed in claim 1 wherein the at least one item indicating a function is displayed in the second portion.

4. A method as claimed in claim 1 wherein the completion of the trace user input enables the function indicated by the at least one item to be performed.

5. A method as claimed in claim 4 wherein a visual indication is provided on the touch sensitive display to indicate that the function will be enabled on completion of the trace user input.

6. A method as claimed in claim 1 wherein the function which is performed comprises changing the content displayed in the first portion from content associated with a first task to content associated with a second task.

7. A method as claimed in claim 1 wherein the function which is performed comprises minimising the first portion.

8. A method as claimed in claim 1 wherein the function which is performed comprises closing the first portion.

9. A method as claimed in claim 1 wherein the boundaries of the first portion and the second portion are indicated on the touch sensitive display.

10. A method as claimed in claim 1 wherein content displayed in one portion does not obscure content displayed in the other portion.

11. A method as claimed in claim 1 wherein the second portion is configured to display an item indicating the content currently displayed in the first portion.

12. A method as claimed in claim 1 wherein the first portion comprises a plurality of tabs such that a first tab is associated with a first task and a second tab is associated with a second, different task wherein the first and second tasks run simultaneously.

13. A method as claimed in claim 1 wherein the plurality of tasks are associated with the same application.

14. An apparatus comprising:
at least one processor; and
at least one memory including computer program code;
wherein the at least one memory and the computer program code are configured to, with the at least one processor, enable the apparatus to:
provide a first portion and a second portion of a touch sensitive display wherein the first portion is configured to display content relating to at least one of a plurality of available tasks and the second portion is configured to enable a user to make a user input to control the first portion;
detect a user input in the second portion;
enable the touch sensitive display to display, in response to the detected user input, at least one item indicating a function which may be performed on the first portion.

15. An apparatus as claimed in claim 14 wherein the user input comprises a trace user input.

16. An apparatus as claimed in claim 14 wherein the apparatus is configured to display the at least one item indicating a function in the second portion of the touch sensitive display.

17. (canceled)

18. (canceled)

19. (canceled)

20. (canceled)

21. (canceled)

22. (canceled)

23. (canceled)

24. (canceled)

25. (canceled)

26. (canceled)

27. A physical entity comprising a computer program comprising computer program instructions that, when executed by at least one processor, enable an apparatus at least to perform:
providing a first portion and a second portion of a touch sensitive display wherein the first portion is configured to display content relating to at least one of a plurality of available tasks and the second portion is configured to enable a user to make a user input to control the first portion;
detecting a user input in the second portion;
displaying, in response to the detected user input, at least one item indicating a function which may be performed on the first portion.

28. A physical entity comprising a computer program comprising computer program instructions for causing a computer to perform the method of claim 1.

29. (canceled)

30. (canceled)

31. A user interface comprising:
a touch sensitive display:
wherein the touch sensitive display is configured to provide a first portion and a second portion of a touch sensitive display wherein the first portion is configured to display content relating to at least one of a plurality of available tasks and the second portion is configured to enable a user to make a user input to control the first portion;
detect a user input in the second portion; and display, in response to the detected user input, at least one item indicating a function which may be performed on the first portion.

32. A graphical user interface as claimed in claim 31 wherein the user input comprises a trace user input.
